(19) United States
(12) Patent Application Publication
(10) Pub. No.: US 2014/0222896 A1
(43) Pub. Date: Aug. 7, 2014

(54) DISTRIBUTED PROCESSING SYSTEM AND MANAGEMENT METHOD OF DISTRIBUTED PROCESSING SYSTEM

(71) Applicant: Hitachi, Ltd., Tokyo (JP)

(72) Inventor: Michitaka OKUNO, Tokyo (JP)

(73) Assignee: Hitachi, Ltd., Tokyo (JP)

(21) Appl. No.: 14/082,540

(22) Filed: Nov. 18, 2013

(30) Foreign Application Priority Data
Feb. 7, 2013 (JP) 2013-022138

(51) Int. Cl. H04L 29/06

(52) U.S. Cl. CPC H04L 67/42
USPC 709/203

(57) ABSTRACT

A distributed processing system comprising: a plurality of information processing apparatuses for performing information processing; client computers for requesting the information processing; and a management apparatus for managing the information processing apparatuses and the client computers, the client computer sends a request for information processing including a required round trip time (RTT) to the management apparatus, the management apparatus measures RTTa between the management apparatus and the information processing apparatuses and RTTb between the management apparatus and the client computer and requests information processing apparatuses with which absolute values of differences between the RTTa and the RTTb are equal to or less than a predetermined threshold to measure RTTc, the information processing apparatuses measure the RTTc to the client computer, and the management unit assigns the information processing to an information processing apparatus which the transmitted RTTc is equal to or shorter than the required RTT.

### CLAIM OF PRIORITY

The present application claims priority from Japanese patent application JP 2013-22138 filed on Feb. 7, 2013, the content of which is hereby incorporated by reference into this application.

### BACKGROUND

This invention relates to a distributed processing system including information processing apparatuses distributed over a network.

The recent boom of cloud computing accelerates transition from possession to use of information processing equipment. The cloud computing is a style of information processing utilizing a network that allows the users to use services provided by information and communication equipment such as servers and storage installed in a data center without paying attention to the physical configuration or location of the information and communication equipment.

The cloud computing is advantageous over on-premises systems composed of traditional information and communication equipment because of flexible and speedy system configuration and low operation cost; it has been well known mainly in consumer usage such as mailing service or Internet shopping and is currently expanding its application range to enterprise core operations. It is also expected to be applied to the field of social infrastructure such as electric power control and traffic control in the future.

In the case of application to the social infrastructure field, the cloud computing system may be accessed not only by humans through computer terminals but also equipment such as sensors and controlled objects (actuators).

The equipment such as sensors and controlled objects occasionally needs determination of control specifications based on information from the sensors within a specific time period; dedicated on-premises systems have been created to address the issue. If a cloud system is employed to control the equipment such as sensors and controlled objects, communication delay between the equipment and the data center might be a problem.

To solve this problem, it is desirable to use not only a distant data center but also information processing apparatuses distributed to various locations by selecting an information processing apparatus satisfying the required time limit from the distributed information processing apparatuses.

To select an appropriate information processing apparatus, JP 2002-77270 A raises a problem to be solved: To provide a system and a method for reallocating an end user to a mirror server in an area, similar to a user giving a request, by using allocation for making the response time as viewed from the user of the contents delivery system to be shortest.

JP 2002-77270 A provides a solution: In the method, network delay a per byte, which a constitution element giving the request observes, is estimated at a prescribed geographical position, while a prescribed server retrieves data by using TCP log. The method includes a step for calculating direct reciprocating delay between the server and the constitution element making the request and a step for deciding the network delay a per byte.

JP 2010-74604 A raises a problem to be solved: To provide a data access system in which a response time of read or write is shortened and the occurrence of network congestion is reduced.

JP 2010-74604 A provides a solution: A data access system comprises a coordinate storage means 85 for storing coordinates of data processing apparatuses storing distributed data. Each data processing apparatus 71 comprises a coordinate determination means 81 for determining coordinates of the apparatus's own on a computer network from a measurement result of communication delay with a predetermined apparatus and a data storage means 82 for storing distributed data. Furthermore, the data access system includes an access destination determination means 83 for determining a data processing apparatus that becomes a read destination or a write destination, from a list of coordinates of data processing apparatus to become candidates of read destination or write destination of the distributed data, on the basis of a distance between the coordinates of the candidates and the coordinates of the apparatus's own.

### SUMMARY

Assuming that the sensors and the controlled objects are clients of a cloud computing system, to assign an information processing apparatus that can communicate with a client within a specific communication delay, it is required to measure communication delays or RTTs (Round Trip Times) between the client and information processing apparatuses. For one of the information processing apparatuses located in a plurality of areas to satisfy the RFT requirement of the client, a large number, for example, more than 1,000, of information processing apparatuses need to be distributed to various areas. Measuring RTTs between all the information processing apparatuses and the client has a problem such that too many measurement requests issued to the client might cause the client to go down or inhibit the client from accurately measuring RTTs because of increase in processing load.

Furthermore, measuring RTTs with all information processing apparatuses generates useless network traffic because only one information processing apparatus is selected as the result of measurements that satisfies the RTT requirement.

Accordingly, a problem to be solved is, in selecting an information processing apparatus appropriate for a client, to prevent inaccurate RTT measurements by preventing the client from being overloaded because of measurement of RTTs between information processing apparatuses and the client. In the meanwhile, minimizing the traffic generated by useless RTT measurement is also a problem to be solved.

A representative aspect of the present disclosure is as follows. A distributed processing system comprising: a plurality of information processing apparatuses for performing information processing; one or more client computers for requesting the information processing; and a management apparatus for managing the plurality of information processing apparatuses and the one or more client computers, the plurality of information processing apparatuses, the one or more client computers, and a management apparatuses being coupled via a network, wherein one of the one or more client computers sends the management apparatus a request for information processing including a required round trip time of a value required for a round trip time, wherein the management apparatus includes: a management unit for selecting an information processing apparatus to perform the information processing requested by the client computer from the plurality of information processing apparatuses and assigning the information processing requested by the client computer to the selected information processing apparatus; and a communication delay measurement unit for measuring round trip times via the network, wherein the communication delay measurement unit measures first round trip times between the management apparatus and the plurality of information processing apparatuses and a second round trip time between the management apparatus and the client computer and requests information processing apparatuses with which absolute values of differences between the first round trip times and the second round trip time are equal to or less than a predetermined threshold to measure third round trip times between the information processing apparatuses and the client computer, wherein the information processing apparatuses measure the third round trip times to the client computer and transmit the measured third round trip times to the management apparatus, and wherein the management unit assigns the information processing requested by the client computer to an information processing apparatus to which the transmitted third round trip time is equal to or shorter than the required round trip time of the client computer.

This invention minimizes the load to a client computer generated by measurement of RTTs between information processing apparatuses and the client computer to achieve accurate RTT measurement. Furthermore, this invention achieves selection of an information processing apparatus that satisfies the RTT requirement of the client computer with minimum traffic generated by useless RTT measurement.

### BRIEF DESCRIPTION OF THE DRAWINGS

FIG. 1 shows the first embodiment of this invention, and is a block diagram illustrating an example of a distributed processing system.

FIG. 2 shows the first embodiment of this invention, and is a diagram providing concept of communication delays measured among the management apparatus, a communication and information processing apparatus, and the client.

FIG. 3 shows the first embodiment of this invention, and is a sequence diagram illustrating an example of processing performed in the distributed processing system.

FIG. 4 shows the first embodiment of this invention, and is a sequence diagram illustrating an example of processing performed between the client and the communication and information processing apparatus and between the client and the DNS server.

FIG. 5 shows the first embodiment of this invention, and is a sequence diagram illustrating an example of registering a communication and information processing apparatus in the distributed processing system.

FIG. 6 shows the first embodiment of this invention, and is a sequence diagram illustrating an example of selecting a communication and information processing apparatus from the distributed processing system.

FIGS. 7A and 7B show the first embodiment of this invention, and are flowcharts illustrating an example of selecting a communication and information processing apparatus performed by the management apparatus.

FIG. 8 shows the first embodiment of this invention, and is a block diagram illustrating an example of the configuration of the communication and information processing apparatus.

FIG. 9 shows the first embodiment of this invention, and is a block diagram illustrating an example of the configuration of the management apparatus.

FIG. 10 shows the first embodiment of this invention, and illustrates a configuration example of the communication and information processing apparatus management table.

FIG. 11 shows the third embodiment of this invention, and is a block diagram illustrating an example of distributed processing system.

FIG. 12 shows the third embodiment of this invention, and is a sequence diagram illustrating an example of processing to register a communication and information processing apparatus in the distributed processing system.

FIG. 13 shows the third embodiment of this invention, and is a sequence diagram illustrating an example of selecting a communication and information processing apparatus in the distributed processing system.

FIG. 14 shows the fourth embodiment of this invention, and is a block diagram illustrating an example of the configuration of the information processing function unit.

### DETAILED DESCRIPTION OF THE EMBODIMENTS

Hereinafter, embodiments of this invention are described based on the accompanying drawings. The same reference signs in the drawings denote the same or equivalent elements. For convenience of explanation, suffixes may be added to the reference signs for discrimination.

### Embodiment 1

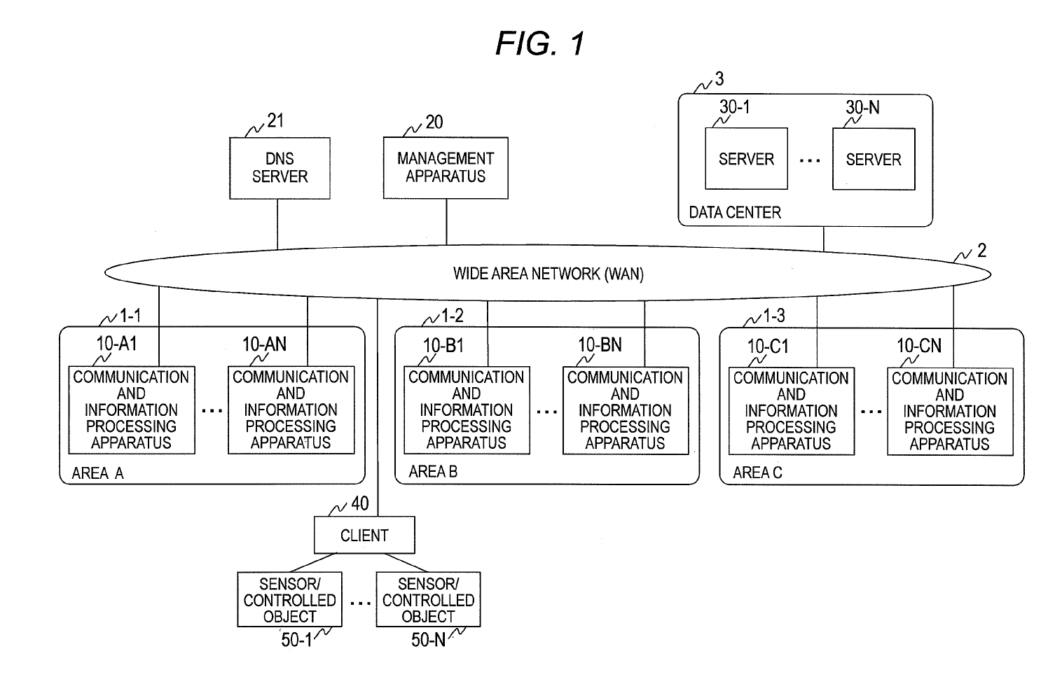

This embodiment employs a system including a data center 3, a management apparatus 20, a DNS server 21, a plurality of communication and information processing apparatuses 10 distributed to areas 1-1 to 1-3, and a client (client computer) 40 aggregating sensors or controlled objects 50 coupled to a wide area network (WAN) 2 as shown in FIG. 1 by way of example to describe a method of selecting and assigning a communication and information processing apparatus 10 appropriate for the client 40. The areas 1-1 to 1-3 are generally denoted by the reference sign 1 where the suffixes following a hyphen are omitted. The same applies to the other elements.

FIG. 1 is a block diagram illustrating an example of a distributed processing system. In the distributed processing system of this invention, each area 1 includes a plurality of communication and information processing apparatuses 10 coupled to the WAN 2. As will be described later, the management apparatus 20 assigns information processing requested by the client 40 to one of the plurality of communication and information processing apparatus 10. The client 40 includes sensors and controlled objects such as actuators (hereinafter, sensors/controlled objects) 50-1 to 50-N and requests the management apparatus 20 for their control. The management apparatus 20 selects a most appropriate communication and information processing apparatus 10 satisfying the requirements of the client 40 to assign the control processing to the apparatus 10.

An area 1-1 (Area A) includes communication and information processing apparatuses 10-A1 to 10-AN; an area 1-2 (Area B) includes communication and information processing apparatuses 10-B1 to 10-BN; and an area 1-3 (Area C) includes communication and information processing apparatuses 10-C1 to 10-CN. In each area 1, the plurality of communication and information processing apparatuses 10 are coupled to one another. Each area 1 may include a network (local network) coupling the communication and information processing apparatuses 10 to one another.

The management apparatus 20 receives a processing request from the client 40 through the data center 3, selects a most appropriate communication and information processing apparatus 10 among the apparatuses in the various areas 1, and assigns the processing for the client 40 to the selected apparatus. The data center 3 includes a plurality of servers 30-1 to 30-N.

FIG. 1 shows an example coupled via a WAN 2, but it is sufficient if the network allows communication, regardless of wired or wireless. FIG. 1 shows a single client 40 but a plurality of clients 40 may be coupled to the WAN 2.

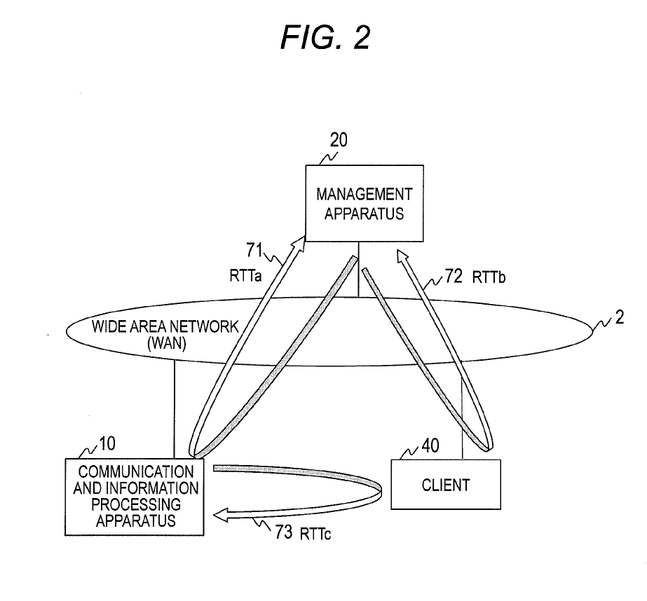

FIG. 2 is a diagram providing concept of communication delays measured among the management apparatus 20, a communication and information processing apparatus 10, and the client 40.

This invention uses three kinds of round trip times (RTTs) as illustrated in FIG. 2. The first RTT is RTTa 71, which is a round trip time (hereinafter RTT) between the management apparatus 20 and the communication and information processing apparatus 10; the second RTT is RTTb 72, which is an RTT between the management apparatus 20 and the client 40; and the third RTT is RTTc 73, which is an RTT between the communication and information processing apparatus 10 and the client 40.

### <Configuration Example of Processing Apparatus>

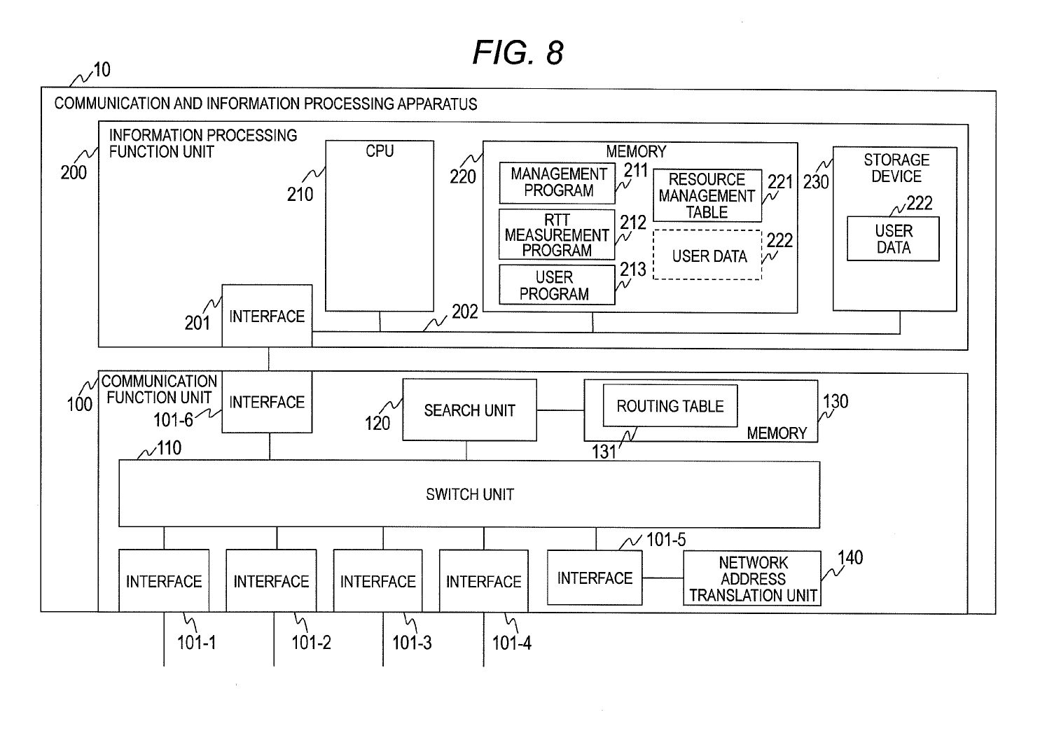

Now, the apparatuses included in the distributed processing system of this invention are explained hereinafter. FIG. 8 is a block diagram illustrating an example of the configuration of the communication and information processing apparatus 10.

The communication and information processing apparatus 10 includes a communication function unit 100 and an information processing function unit 200. The communication function unit 100 can be made of a Layer 3 switch having a network address translation function. The communication function unit 100 includes a plurality of interfaces 101: interfaces 101-1, 101-2, 101-3, and 101-4 to the WAN 2 (network), an interface 101-6 to the information processing function unit 200, and an interface 101-5 to the network address translation unit 140 in the example of FIG. 8. These interfaces 101 are coupled to a search unit 120 via a switch unit 110. The search unit 120 searches a routing table 131 in a memory 130 for the destination of a received packet and transfers the packet from the proper interface 101 based on the search result.

If the destination of a packet received at one of the interfaces 101-1 to 101-4 is the information processing function unit 200 of the communication and information processing apparatus 10, the packet can be transferred, for example, by using the network address translation unit 140.

In the distributed processing system of this invention, when the client 40 requests the management apparatus 20 to perform processing, the management apparatus 20 receives a program desired by the user. The management apparatus 20 assigns a virtual IP address to the communication and information processing apparatus 10 to execute the program desired by the user and notifies the client 40 of it. The client 40 communicates with the communication and information processing apparatus 10 with the assigned IP address.

When the communication and information processing apparatus 10 receives a packet from a client 40 of a registered user, the virtual IP address used for the user program is translated to a predetermined IP address of the network address translation unit 140 based on the search result of the search unit 120 and the packet is transferred to the network address translation unit 140.

The network address translation unit 140 translates the destination IP address of the packet from this client 40 into the IP address assigned to the information processing function unit 200 and transfers it to the switch unit 110. The search unit 120 searches for the destination of the packet again and as a result, the packet of the client 40 is transferred to the information processing function unit 200 to be processed by the user program.

The information processing function unit 200 can be made of a general-purpose server. The information processing function unit 200 typically includes an interface 201, a CPU 210, a memory 220, and a storage device 230, which are coupled via an internal bus 202. The interfaces 101-1 to 101-4, 101-6, and 201 can be network interfaces.

The CPU 210 runs a management program 211 for managing the resources of the communication and information processing apparatus 10, an RTT measurement program 212 for measuring at least the RTTc 73 of the RTT to the client 40, and a user program 213 functioning as a server program for the client 40.

The memory 220 stores a resource management table 221 to be used by the management program 211 on the CPU 210 and a user data 222 to be used by the user program 213 in addition to the above-mentioned management program 211, RTT measurement program 212, and user program 213. Although omitted in the drawing, the OS run on the CPU 210, the tables and data used in the memory 220, and the programs are loaded from the storage device 230 at the activation of the information processing function unit 200. As to the user data 222, it is sufficient that a part of it be held in the memory 220.

The CPU 210 operates in accordance with programs for function units to work as the function units for implementing predetermined functions. For example, the CPU 210 operates in accordance with the RTT measurement program 212 to function as an RTT measurement unit. The same applies to the other programs. Furthermore, the CPU 210 operates as function units for implementing a plurality of processes executed by each program. The computer and the computer system are the apparatus and the system including these function units.

The information such as programs and tables for implementing the functions of the information processing function unit 200 can be stored in a storage device such as the storage device 230, a non-volatile semiconductor memory, a hard disk drive, or an SSD (Solid State Drive), or a computer-readable non-transitory data storage medium such as an IC card, an SD card, or a DVD.

FIG. 8 shows only one information processing function unit 200, but the communication and information processing apparatus 10 may include a plurality of information processing function units 200. Furthermore, FIG. 8 shows only one CPU 210 in the information processing function unit 200, but a plurality of CPUs may be used.

### <Configuration of Management Apparatus>

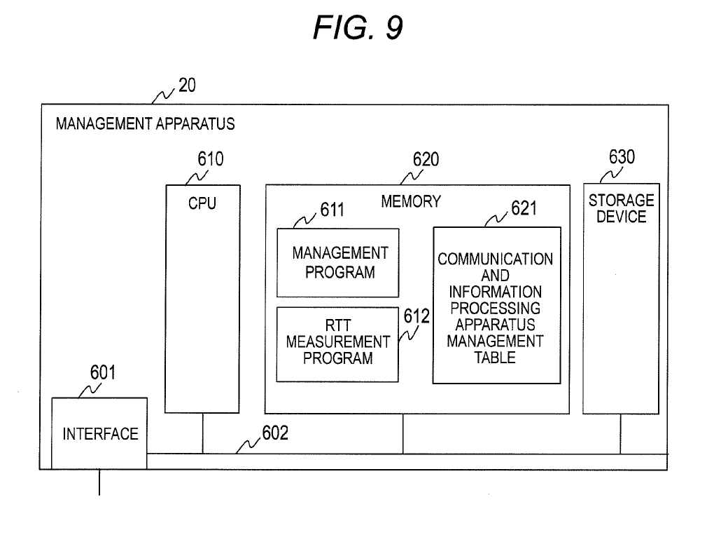

FIG. 9 is a block diagram illustrating an example of the configuration of the management apparatus 20. The management apparatus 20 can be made of a general-purpose server, like the information processing function unit 200. The management apparatus 20 typically includes an interface 601 coupled to the WAN 2, a CPU 610, a memory 620, and a storage device 630, which are coupled via an internal bus 602.

The CPU 610 runs a management program 611 for managing the resources of all the communication and information processing apparatuses 10 in the distributed processing system and assigning a processing request from the client 40 to a communication and information processing apparatus 10 (or the data center 3) and an RTT measurement program 612 for measuring at least the RTTa's 71 of the RTTs to individual communication and information processing apparatuses 10 and the RTTb 72 of the RTT to the client 40. The memory 620 stores a communication and information processing apparatus management table 621 to be used by the management program 611 on the CPU 610 in addition to the management program 611 and the RTT measurement program 612. Although omitted in the drawing, the programs and the OS run on the CPU 610 and the tables and data used in the memory 620 are loaded from the storage device 630 to the memory 620 at the start-up of the management apparatus 20.

The CPU 610 operates in accordance with programs for function units to work as the function units for implementing predetermined functions. For example, the CPU 610 operates in accordance with the RTT measurement program 612 to function as an RU measurement unit (communication delay measurement unit). Furthermore, the CPU 610 operates in accordance with the management program 611 to function as a management unit. The same applies to the other programs. Furthermore, the CPU 610 operates as function units for implementing a plurality of processes executed by each program. The computer and the computer system are the apparatus and the system including these function units.

The information such as the programs and tables for implementing the functions of the management apparatus 20 can be stored in a storage device such as the storage device 630, a non-volatile semiconductor memory, a hard disk drive, or an SSD (Solid State Drive), or a computer-readable non-transitory data storage medium such as an IC card, an SD card, or a DVD.

The client 40, the servers 30 in the data center 3, and the DNS server 21 are also made of the same computers as this management apparatus 20.

### <Configuration of Management Table>

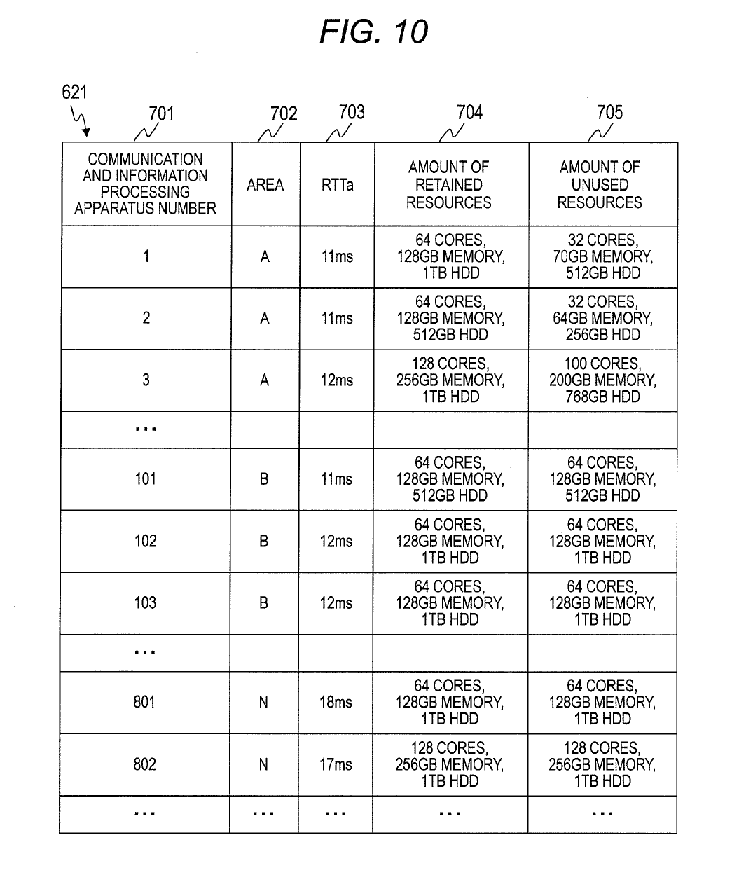

FIG. 10 illustrates a configuration example of the communication and information processing apparatus management table 621 in the management apparatus 20.

The communication and information processing apparatus management table 621 may take various configurations depending on the implementation but it is satisfactory if the RTT between a communication and information processing apparatus 10 and the management apparatus 20 (RTTa 71), the amount of retained resources, and the amount of unused resources (or used resources) of each communication and information processing apparatus 10 can be identified. The amount of resources represents the amount of computer resources of the information processing function unit 200.

For example, the communication and information processing apparatus management table 621 is configured to have entries (or records) each including fields of a communication and information processing apparatus number 701 for identifying a communication and information processing apparatus 10, an area 702 for identifying the area where the communication and information processing apparatus 10 is located, an RTTa 703 for identifying the RTT (RTTa 71) between the communication and information processing apparatus 10 and the management apparatus 20, an amount of retained resources 704 indicating the amount of all resources of the communication and information processing apparatus 10, and an amount of unused resources 705 indicating the amount of unused resources of the communication and information processing apparatus 10.

For the area fields 702, a granularity convenient for the administrator of the distributed processing system to manage communication and information processing apparatuses 10 may be employed. Taking an example of Japan, the areas may be eight blocks: Hokkaido, Tohoku, Kanto, Koshinetsu, Kansai, Chugoku, Kyushu, and Okinawa. Of course, they may be sub-divided into prefectural or municipal levels. Alternatively, the communication and information processing apparatuses 10 may be grouped based on the attribute they belong to so that the management apparatus 20 can manage the communication and information processing apparatuses 10 by group. For the attributes, instead of the geographical or governmental groups, networks coupled from the communication and information processing apparatuses 10 may be the groups to manage the communication and information processing apparatuses 10; for example, individual local IP networks may be employed as the groups for management.

This communication and information processing apparatus management table 621 manages the RTT's and the computer resources of the communication and information processing apparatuses 10 together. In the example of FIG. 10, the communication and information processing apparatus 10 numbered 1 belongs to Area A, communicates with the management apparatus 20 at 11 milliseconds of RTTa, has computer resources of 64 cores, 128 GB memory, and 1 TB hard disk drive, and currently has unused computer resources of 32 cores, 70 GB memory, and 512 GB hard disk drive.

### <Client Registration>

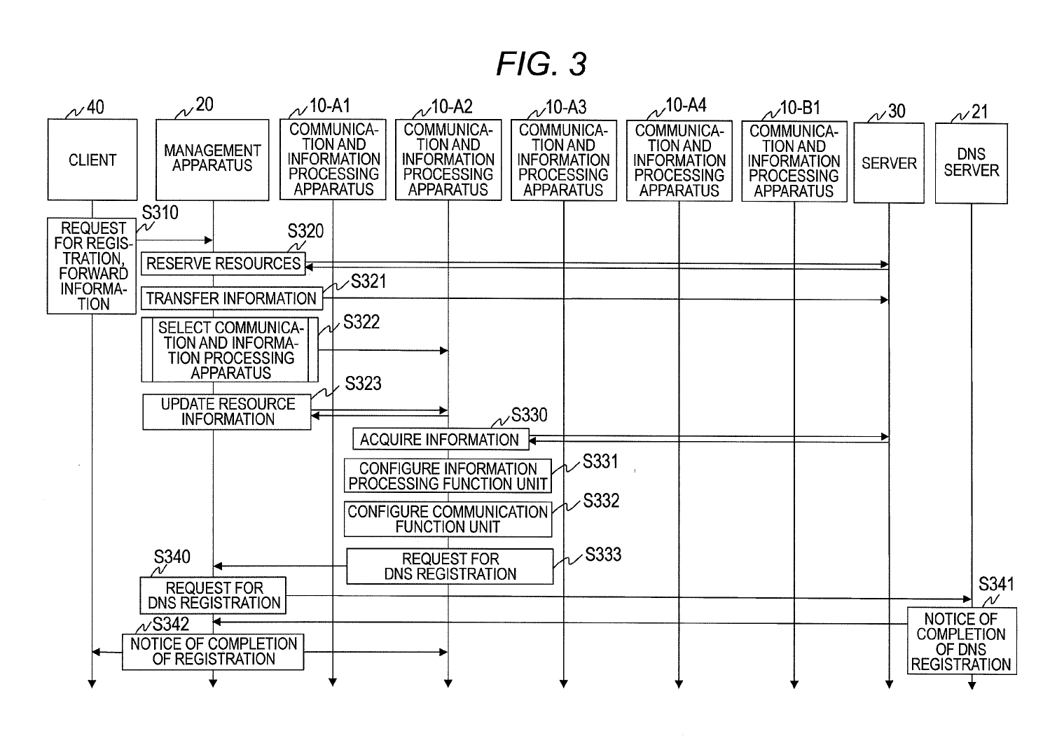

Next, described with FIG. 3 is an example of registering a client 40 in the distributed processing system to which this invention has been applied. FIG. 3 is a sequence diagram illustrating an example of processing performed in the distributed processing system.

The client 40 forwards a request for registration together with information necessary for the processing to the management apparatus 20 (Step S310). The information necessary for the processing includes at least a required round trip time (RTTr) which is an RTT requested by the client to the distributed processing system (for example, 5 milliseconds or less), the IP address of the client 40, the server program (user program 213) to be used in the distributed processing system, and the amount of computer resources such as the amount of memory requested to the distributed processing system. The user program 213 may be a program such that the client 40 sends results of measurements by the sensors to the distributed processing system, the distributed processing system determines the controlled object to be driven and the extent to be driven through computation, and the client 40 controls the object in accordance with the received computation result.

Upon receipt of the request for registration from the client 40, the management apparatus 20 reserves computer resources of a server 30 in the data center 3 (Step S320) and transfers the user program 213 received from the client 40 to the reserved server 30 (Step S321).

Successively, the management apparatus 20 selects an information processing apparatus (a server 30 in the data center 3 or one of the communication and information processing apparatuses 10) satisfying the required RTTr of the client 40 using the procedure of this invention (Step S322). The details of this procedure will be described later. In the example shown in the drawing, the communication and information processing apparatus 10-A2 is selected out of the plurality of communication and information processing apparatuses 10.

The management apparatus 20 updates information about the computer resources such as the CPUs and the memory of the selected communication and information processing apparatus 10-A2 assigned the processing for the client 40 (Step S323). Specifically, the management apparatus 20 updates the information with the information obtained by deducting the amount of computer resources to execute the user program 213 from the amount of unused resources 705 of the communication and information processing apparatus 10-A2 assigned the user program 213.

Upon selection of a communication and information processing apparatus 10, the selected communication and information processing apparatus 10-A2 acquires information including the user program 213 from the server 30 in the data center 3 (Step S330).

The selected communication and information processing apparatus 10-A2 configures its own information processing function unit 200 so as to be ready to use the received user program 213 (Step S331) and further configures its own communication function unit 100, with respect to the routing and other setting, so as to be able to transfer communications with the client 40 to the user program 213 (Step S332).

Upon completion of the configuration up to Step S332, the selected communication and information processing apparatus 10-A2 sends the management apparatus 20 a request to register a virtual IP address in the WAN 2 of the received user program 213 in the DNS server 21 (Step S333). As will be described later, the virtual IP address is an address used by the client 40 as a destination address.

Upon receipt of the request for registration in the DNS server 21 from the communication and information processing apparatus 10-A2, the management apparatus 20 sends the DNS server 21 a request for DNS registration of the virtual IP address (Step S340).

Upon receipt of the DNS registration request from the management apparatus 20, the DNS server 21 creates a URL to be linked with the virtual IP address of the user program 213 and notifies the management apparatus 20 of it (Step S341). Although the DNS server 21 is generally composed of a plurality of hierarchical servers, this embodiment employs a single layer DNS server 21 for simplicity of explanation.

Upon receipt of a notice of completion of registration including the URL from the DNS server 21, the management apparatus 20 notifies the communication and information processing apparatus 10-A2 and the client 40 of the URL for the virtual IP address to complete the registration of the client 40 in the distributed processing system (Step S342).

At Step S342, the management apparatus 20 may notify the communication and information processing apparatus 10-A2 and the client 40 of the virtual IP address together with the URL so that the client 40 can directly access the virtual IP address instead of the URL. Meanwhile, if the client 40 does not use the URL, the management apparatus 20 may skip Steps S340 and S341 and notify the client of the virtual IP address only.

Through the above-described processing, the management apparatus 20 registers the client 40 in the distributed processing system and assigns the communication and information processing apparatus 10-A2 to execute the user program 213 to the client 40.

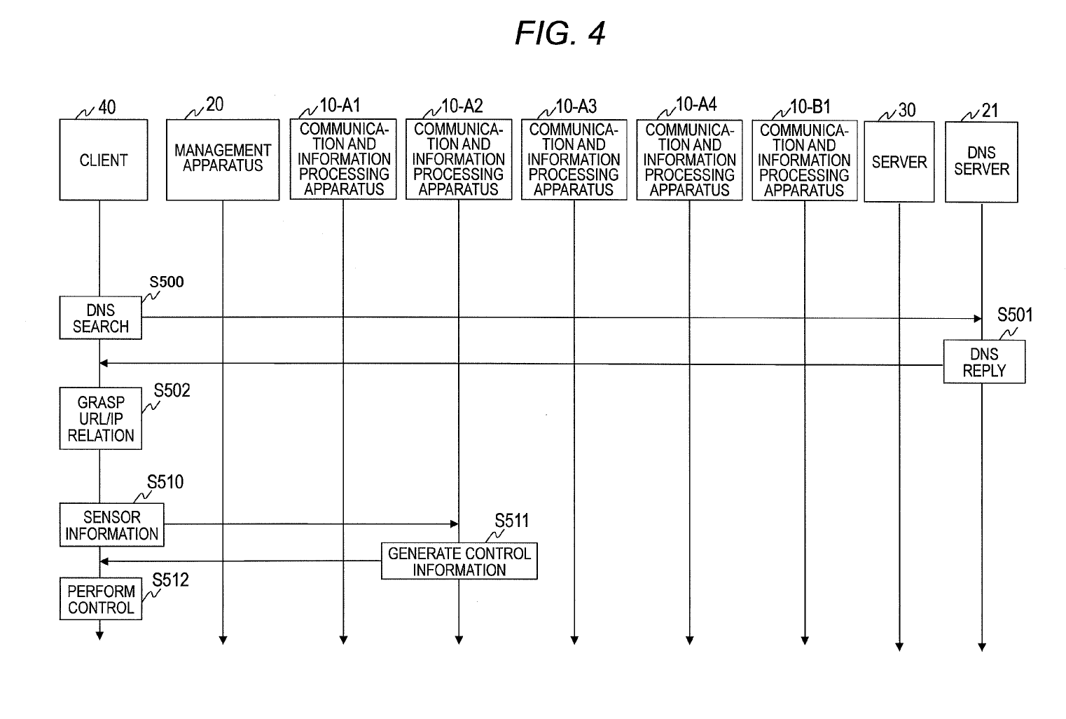

Next, described with FIG. 4 is a procedure for the client 40 to perform information processing using the distributed processing system to which this invention has been applied.

FIG. 4 is a sequence diagram illustrating an example of processing performed between the client 40 and the communication and information processing apparatus 10-A2 and between the client 40 and the DNS server 21 in the processing performed in the distributed processing system.

If the client 40 has not acquired a virtual IP address for the user program 213 registered in the distributed processing system, it sends a DNS search request to the DNS server 21 with the URL assigned by the management apparatus 20 (Step S500).

Upon receipt of the DNS search request from the client 40, the DNS server 21 searches for the IP address corresponding to the URL and notifies the client 40 of the IP address (virtual IP address) (Step S501).

Upon receipt of the DNS search result from the DNS server 21, the client 40 becomes in the state where it has acquired the IP address corresponding to the URL (Step S502). If the client 40 has been notified of the virtual IP address together with the URL or solely by the management apparatus 20, the steps S500, S501, and S502 can be skipped.

Thereafter, when the client 40 receives sensor information from sensors/controlled objects 50, it designates the virtual IP address as the destination IP address to transfer the sensor data to the distributed processing system (Step S510).

Upon receipt of the sensor data, the communication and information processing apparatus 10-A2 assigned the virtual IP address in the distributed processing system transfers the sensor data to the executor (for example, its own information processing function unit 200) using its own communication function unit 100, performs the processing to generate control information, and returns the result to the client 40 via the reverse route (Step S511).

Upon receipt of the control information from the communication and information processing apparatus 10-A2, the client 40 performs control to the sensors/controlled objects 50 based on the control information (Step S512).

### <Selecting Communication and Information Processing Apparatus>

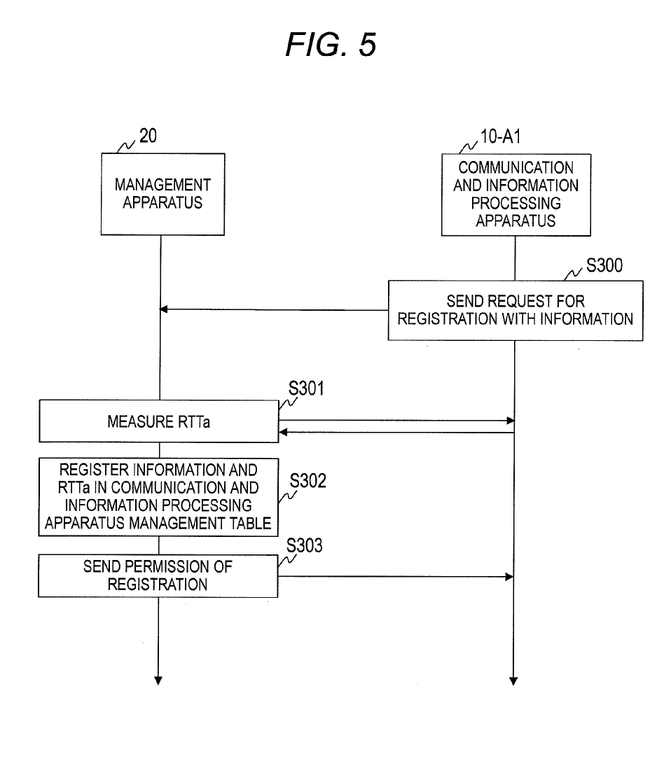

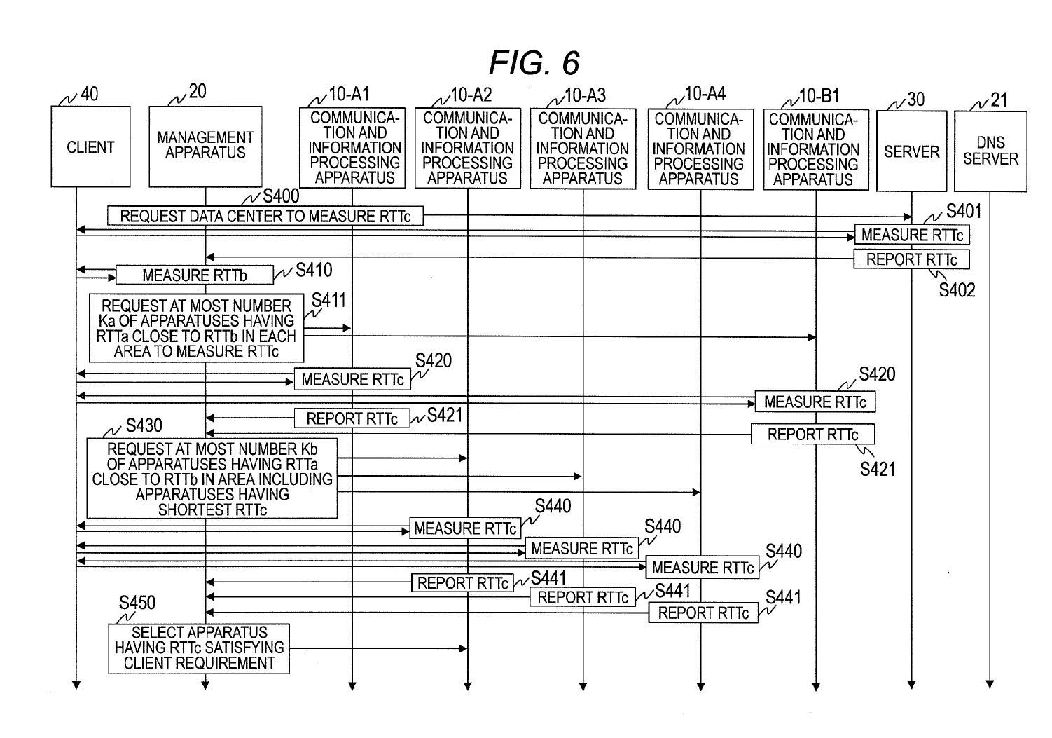

Next, the processing at Step S322 in FIG. 3 to select a communication and information processing apparatus 10 satisfying the required RTTr of the client 40 is described in detail with FIGS. 5 and 6. The required RTTr is determined depending on the client 40 and is used as a threshold to be compared with the communication delay RTTc 73 to the communication and information processing apparatus 10 or the server 30 to execute the processing for the client 40.

FIG. 5 is a sequence diagram illustrating an example of registering a communication and information processing apparatus in the distributed processing system. FIG. 6 is a sequence diagram illustrating an example of selecting a communication and information processing apparatus from the distributed processing system.

First, the procedure to newly register a communication and information processing apparatus 10 in the distributed processing system is described with FIG. 5.

The communication and information processing apparatus 10 sends a request for registration to the management apparatus 20 together with information on the same apparatus 10 (for example, the area name the apparatus 10 belongs to, the number of CPU cores, the amount of memory, and the size of hard disk held by the apparatus 10, and the type of the OS as necessary) (Step S300).

Upon receipt of the registration request from the communication and information processing apparatus 10, the management apparatus 20 measures the RTT to the communication and information processing apparatus 10 (Step S301) and registers it as an RTTa in the RTTa field 703 in the communication and information processing apparatus management table 621. The management apparatus 20 further registers information on the communication and information processing apparatus 10 in the fields of the area 702 and the amount of retained resources 704 (Step S302). After the registration, the management apparatus 20 sends a permission of registration to the communication and information processing apparatus 10 (Step S303).

Each time the management apparatus 20 repeats the processing of Steps S300 to S303 in FIG. 5, a communication and information processing apparatus 10 can be registered in the distributed processing system. When the operator completes registration of a desired number of communication and information processing apparatuses 10 in the distributed processing system, the distributed processing system becomes ready to provide a service to the user who operates the client 40.

FIG. 6 is a sequence diagram illustrating an example of selecting a communication and information processing apparatus from the distributed processing system. Next, described in detail with FIG. 6 is processing to select a communication and information processing apparatus 10 satisfying the required RTTr of the client 40 from the distributed processing system that is ready to provide a service to the user.

Upon receipt of a request for registration from the client 40, the management apparatus 20 requests a server 30 in the data center 3 to measure the RTTc 73 of the RTT between the server 30 and the client 40 (Step S400).

Upon receipt of the request to measure the RTTc 73 from the management apparatus 20, the server 30 in the data center 3 measures the RTTc 73 to the client 40 using a ping command or other command (Step S401). The server 30 in the data center 3 notifies the management apparatus 20 of the measured RTTc 73 (Step S402).

Up to this step, the management apparatus 20 can grasp the RTT between the client 40 and the server 30 in the data center 3. If this RTT satisfies the required RTTr of the client 40, the management apparatus 20 can assign the server 30 in the data center 3 to the client 40 as in the traditional cloud system.

If the RTT between the client 40 and the server 30 in the data center 3 does not satisfy the required RTTr of the client 40, the management apparatus 20 has to assign a communication and information processing apparatus 10 satisfying the required RTTr to the client 40.

Hence, the management apparatus 20 measures the RTTb 72 of the RTT from the management apparatus 20 to the client 40 (Step S410).

The management apparatus 20 searches the communication and information processing apparatus management table 621 and selects at most a predetermined number Ka (first predetermined number) of communication and information processing apparatuses 10 each having an RTTa close to the measured RTTb in the field of RTTa 703 and having unused resources in the amount required by the client 40 in the field of amount of unused resources 705 from each area 1 having a different value in the field of area 702. The management apparatus 20 requests each of them to measure the RTTc 73 of the RTT to the client 40 (Step S411).

Here, the communication and information processing apparatus 10 having an RTTa close to the measured RTTb 72 from the management apparatus 20 to the client 40 in the communication and information processing apparatus management table 621 means that the difference ΔRTT between the communication delay RTTb 72 from the management apparatus 20 to the client 40 and the communication delay RTTa from the management apparatus 20 to the communication and information processing apparatus 10 is within a predetermined range, which is expressed as ΔRTT=|RTTa−RTTb|≦ΔTh.

In this formula, ΔTh denotes a threshold representing a predetermined range for the difference ΔRTT and is determined at a value of, for example, 30 milliseconds. The threshold ΔTh may be a fixed value throughout the distributed processing system or may be determined at a different value for each client 40. The value of the threshold ΔTh can be changed as appropriate depending on the number of areas or the total number of communication and information processing apparatuses 10.

The management apparatus 20 selects a predetermined number Ka of communication and information processing apparatuses 10 having the substantially same communication delay as the communication delay to the client 40 from each area 1. That is to say, the management apparatus 20 selects the number Ka of communication and information processing apparatuses 10 having the almost same delay time from the management apparatus 20, meaning temporally located at the equal distance from the management apparatus 20, as representatives of each area 1 to measure the RTTc 73. The number Ka for the communication and information processing apparatuses 10 to be selected from each area 1 is predetermined to be, for example, one or a few based on the number of areas 1 or the number of communication and information processing apparatuses 10. FIG. 6 shows a case where Ka=1.

Each communication and information processing apparatus 10 requested to measure the RTTc 73 by the management apparatus 20 measures the RTTc 73 of the RTT to the designated client 40 (Step S420) and notifies the management apparatus 20 of the measured RTTc 73 (Step S421).

Upon receipt of measured RTTc's 73 from all the selected communication and information processing apparatuses 10, the management apparatus 20 determines whether any RTTc 73 satisfies the required RTTr of the client 40. If one RTTc 73 satisfies the required RTTr, the management apparatus 20 assigns the communication and information processing apparatus 10 having the RTTc 73 to the client 40 (Step S450). If a plurality of RTTc's 73 satisfy the required RTTr, the management apparatus 20 selects the communication and information processing apparatus 10 having the shortest RTTc 73 and assigns the processing for the client 40 to it (Step S450).

If there is no RTTc 73 satisfying the required RTTr, the management apparatus 20 searches the communication and information processing apparatus management table 621 and selects at most an operator-specified number (for example, Kb) of communication and information processing apparatuses 10 each having an RTTa close to the RTTb in the field of RTTa 703 (meaning the absolute value of the difference ΔRTT is equal to or less than the threshold ΔTh) and having unused resources in the amount required by the client 40 in the field of amount of unused resources 705 from the area having the shortest RTTc 73. Here, the value for the specified number Kb (second predetermined number) is determined at, for example, a number less than 10 and usually, about 3. The management apparatus 20 requests each of the selected number Kb of communication and information processing apparatuses 10 to measure the RTTc 73 to the client 40 (Step S430).

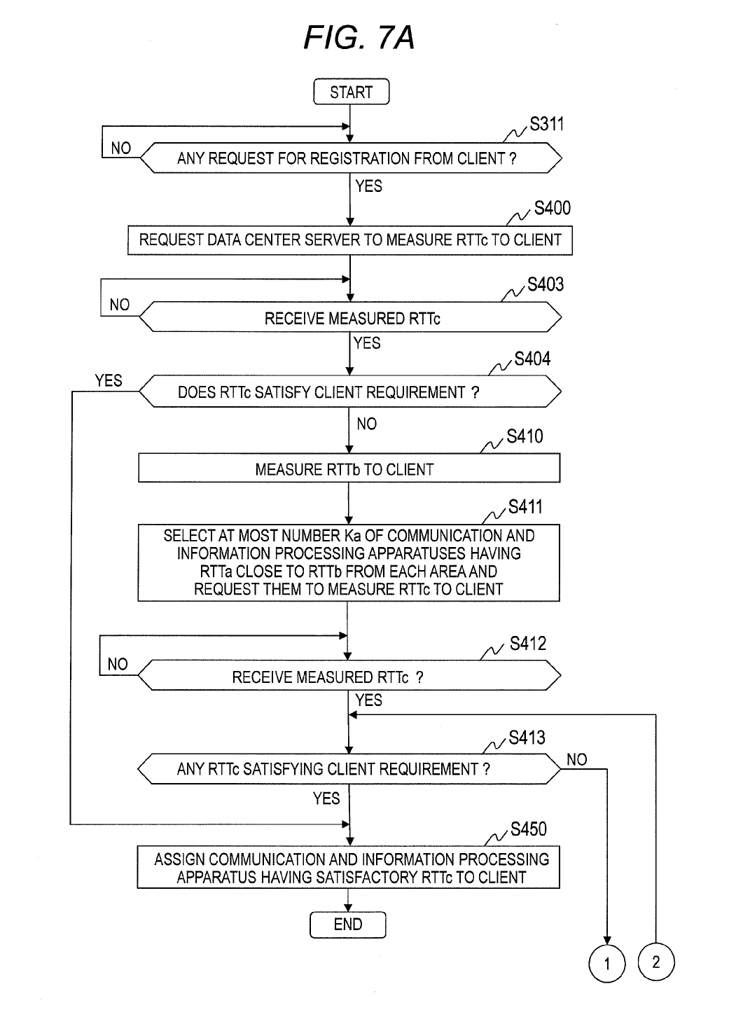

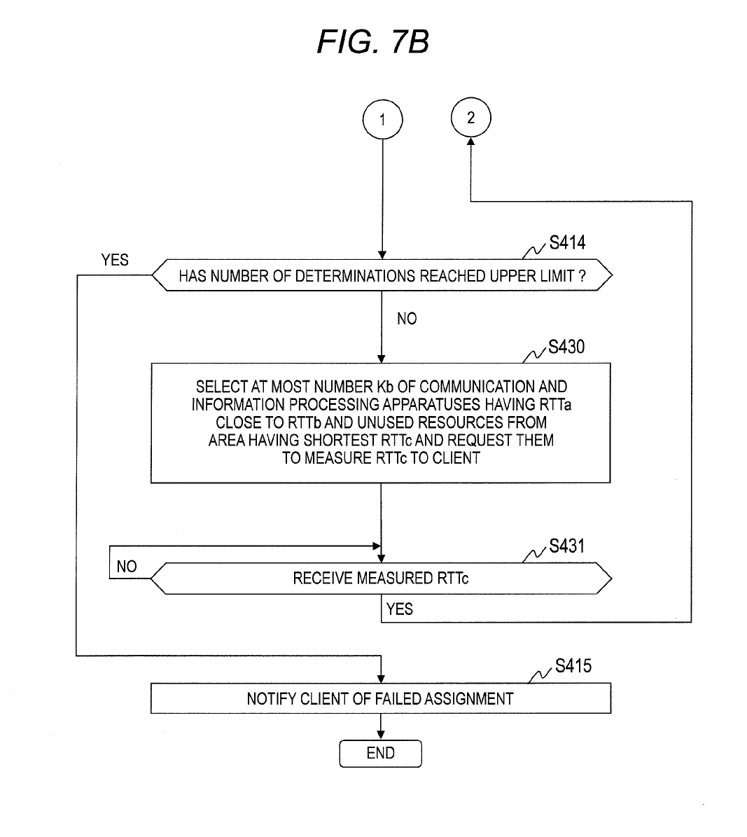

The exact control method to Step S430 will be described later with reference to FIGS. 7A and 7B illustrating the processing of the management apparatus 20, particularly Step S414 and subsequent steps in the flowcharts.

Upon receipt of the request to measure the RTTc 73 from the management apparatus 20, each communication and information processing apparatus 10 measures the RTTc 73 to the designated client 40 (Step S440) and notifies the management apparatus 20 of the measured RTTc 73 (Step S441).

Upon receipt of the measured RTTc's 73 from all the selected communication and information processing apparatuses 10, the management apparatus 20 determines whether any RTTc 73 satisfies the required RTTr of the client 40. If one RTTc 73 satisfies the required RTTr, the management apparatus 20 assigns the communication and information processing apparatus 10 having the RTTc 73 to the client 40. If a plurality of RTTc's 73 satisfy the required RTTr, the management apparatus 20 assigns the communication and information processing apparatus 10 having the shortest RTTc 73 to the client 40 (Step S450).

In the above-described processing, the management apparatus 20 first measures the communication delay RTTb between the management apparatus 20 and the client 40, and selects the number Ka of communication and information processing apparatuses 10 whose communication delays RTTa's between the communication and the information processing apparatuses 10 and the management apparatus 20 measured in advance are close to the communication delay RTTb from each area. Then, the management apparatus 20 requests only the selected number Ka of communication and information processing apparatuses 10 to measure the communication delay RTTc 73 and selects a communication and information processing apparatus 10 whose communication delay RTTc satisfies the required RTTr of the client 40 to assign the apparatus 10 to the client 40.

It should be noted that the processing to the step S450 may not be able to extract a communication and information processing apparatus 10 satisfying the required RTTr. In such a case, the management apparatus 20 repeats Steps S430, S440, and S441 on the unselected communication and information processing apparatuses 10 for a predetermined number of times to extract a communication and information processing apparatus 10 satisfying the required RTTr. If the management apparatus 20 still cannot extract a communication and information processing apparatus 10 satisfying the required RTTr, the management apparatus 20 notifies the client 40 of no assignment. This processing is described from the view point of the management apparatus 20.

FIGS. 7A and 7B are flowcharts illustrating an example of selecting a communication and information processing apparatus 10 performed by the management apparatus 20.

The management apparatus 20 waits for a request for registration of the client 40 in the distributed processing system. Upon receipt of the request for registration from the client 40 (selecting YES at S311 in response to Step S310 in FIG. 3), the management apparatus 20 requests a server 30 in the data center 3 to measure the RTTc 73 of the communication delay to the client 40 (Step S400) and waits for a measured RTTc 73 (Step S401 in FIG. 6).

Upon receipt of the measured RTTc 73 from the server 30 in the data center 3 (selecting YES at S403 in response to Step S402 in FIG. 6), the management apparatus 20 determines whether the RTTc 73 satisfies the required RTTr of the client 40 (Step S404).

If, at Step S404, the RTTc 73 satisfies the required RTTr of the client 40 (selecting YES at S404), the management apparatus 20 assigns the server 30 in the data center 3 to the client 40 and terminates the assignment (corresponding to Step S450).

If, at Step S404, the RTTc 73 does not satisfy the required RTTr of the client 40 (selecting NO at S404), the management apparatus 20 has to assign a communication and information processing apparatus 10 satisfying the required RTTr to the client 40. Hence, the management apparatus 20 measures the RTTb of the communication delay to the client 40 (Step S410).

The management apparatus 20 searches the communication and information processing apparatus management table 621 for communication and information processing apparatuses 10 having values close to the RTTb in the fields of RTTa 703, different values in the fields of area 702, and having unused resources in the amount required by the client 40 in the fields of amount of unused resources 705, selects a number Ka of communication and information processing apparatuses 10 from each area 1, and requests each of them to measure the RTTc 73 of the communication delay to the client 40 (Step S411).

Upon receipt of measured RTTc's 73 from all the communication and information processing apparatuses 10 requested to measure the RTTc 73 (selecting YES at Step S412), the management apparatus 20 determines whether any measured RTTc 73 satisfies the required RTTr of the client 40 (Step S413).

If only one RTTc 73 satisfies the required RTTr, the management apparatus 20 selects YES at Step S413 and assigns the communication and information processing apparatus 10 to the client 40. If a plurality of RTTc's 73 satisfy the required RTTr, the management apparatus 20 selects YES at Step S413 and assigns the communication and information processing apparatus 10 having the shortest RTTc 73 to the client 40 (Step S450).

Step S413 is to be executed for a plurality of times according to the flowchart. Even if the measured RTTc 73 is equal to or shorter than the required RTTr at the first execution, Steps S414 to S431 can be repeated for a plurality of times within a predetermined upper limit because a still shorter RTTc 73 may exist. The management apparatus 20 can select the communication and information processing apparatus 10 having the shortest measured RTTc 73 within the upper limit of the repeats.

If there is no RTTc 73 satisfying the required RTTr, the management apparatus 20 selects NO at Step S413. If the number of repeats of Step S413 has reached the above-mentioned predetermined upper limit at this stage, the management apparatus 20 aborts the processing (selecting YES at Step S414), notifies the client 40 that the required RTTr cannot be satisfied, and terminates the processing.

If the number of determinations of RTTc 73 at Step S413 has not reached the predetermined upper limit (selecting NO at Step S414), the management apparatus 20 searches the communication and information processing apparatus management table 621 for communication and information processing apparatuses 10 having values close to the RTTb in the fields of RTTa 703 and having unused resources in the amount required by the client 40 in the fields of amount of unused resources 705 and selects at most the operator-specified number Kb of communication and information processing apparatuses 10 from the area 1 having the shortest RTTc 73. The management apparatus 20 requests each of the number Kb or less of communication and information processing apparatuses 10 to measure the RTTc 73 to the client 40 (Step S430).

Upon receipt of measured RTTc's 73 from all the communication and information processing apparatuses 10 requested to measure the RTTc 73 (selecting YES at S431), the management apparatus 20 returns to Step S413 to determine whether any of the measured RTTc's 73 satisfies the required RTTr of the client again. Thereafter, it repeats the processing of Steps S413, S414, S430, and S431 and if any communication and information processing apparatus 10 satisfying the required RTTr of the client is extracted within the predetermined number of times, the management apparatus 20 assigns the communication and information processing apparatus 10 to the client 40 and terminates the assignment (S450). If no communication and information processing apparatus 10 can be extracted within the predetermined number of times, the management apparatus 20 notifies the client 40 that the required RTTr cannot be satisfied and terminates the processing (S415).

Here is provided an example. It is assumed that the management apparatus 20 is located at Tokyo; the data center 3 is located at Okinawa; a plurality of communication and information processing apparatuses 10 are distributed all over Japan; and a client 40 in Tohoku area issues a request for registration in the distributed processing system together with a required RTTr of 3 milliseconds. In this case, communication and information processing apparatuses 10 in Tohoku area and communication and information processing apparatuses 10 in Kinki area may be selected as the communication and information processing apparatuses 10 having RTTa's 71 close to the RTTb 72 between the management apparatus 20 and the client 40 at Step S411. Through the processing at Steps S420 and S421 in FIG. 6, communication and information processing apparatuses 10 in Tohoku area are selected.

Subsequently, from the communication and information processing apparatuses 10 in Tohoku area, communication and information processing apparatuses 10 having RTTa's 71 to the management apparatus 20 close to the RTTb between the management apparatus 20 and the client 40 are selected at Step S430 and a communication and information processing apparatus 10 having an RTTc 73 to the client 40 satisfying the required RTTr out of the communication and information processing apparatuses 10 in Tohoku area through the processing at Steps S440 and S441.

Embodiment 1 has provided an example where the management apparatus 20 actively measures RTTa's 71 of the RTTs between the management apparatus 20 and communication and information processing apparatuses 10 and the RTTb 72 of the RTT between the management apparatus 20 and the client 40. In similar, Embodiment 1 has provided an example where each communication and information processing apparatus 10 actively measures the RTTc 73 of the RTT between the communication and information processing apparatus 10 and the client 40. This is because the management apparatus 20 and the communication and information processing apparatuses 10 are assumed to be provided by the operator of the distributed processing system and the client 40 is assumed to be provided by the user. In such conditions, the management apparatus 20 and the communication and information processing apparatuses 10 actively measure the communication delays to reduce the load to the client 40.

However, the agent of RTT measurement does not need to be limited. In other words, the communication and information processing apparatus 10 may measure the RTTa 71 and the client 40 may measure the RTTb 72 and the RTTc 73.

As set forth above, the first embodiment of this invention has been described. This invention accomplishes selection of a communication and information processing apparatus 10 satisfying an RTT requirement of the client 40 and minimum increase in load to the client 40 because the client 40 receives only the number Ka (less than 10 and usually about 3) or less of requests to measure the RTTc 73 from communication and information processing apparatuses 10 in each area 1 at once. Since the processing load to the client 40 in measuring RTTc's 73 is low, accurate RTT measurement can be achieved. As described in SUMMARY OF THE INVENTION, the RTTs measured by an overloaded client 40 may be inaccurate; however, this invention can achieve a lower processing load to the client 40.

In the whole distributed processing system, the traffic in measuring the RTTc's 73 is generated Ka×the number of areas or Kb×the times of upper limit at most, which is sufficiently light assuming that the total number of communication and information processing apparatuses 10 in the distributed processing system is about 1,000. This invention can prevent the traffic for RTT measurements generated at registration of a client 40 from being excessively heavy.

### Embodiment 2

Embodiment 1 described, for simplicity of explanation, an example where a user can register only one client 40 in the distributed processing system at once; in practice, however, there frequently happens a case where a user registers a plurality of clients 40. Hence, Embodiment 2 describes a case where a user has a plurality of clients 4.

The system configuration image in Embodiment 2 can be considered as the one including a plurality of clients 40, compared with FIG. 1. The basic idea to select communication and information processing apparatuses 10 and assign them to the clients conforms to that of Embodiment 1.

Specifically, for each of the plurality of clients 40, processing to assign a communication and information processing apparatus 10 should be performed in accordance with the procedure described in Embodiment 1. Through this processing, each client 40 can be assigned a communication and information processing apparatus 10 satisfying a required RTTr.

In the meanwhile, there may happen a case where a single communication and information processing apparatus 10 has to process information from a plurality of clients 40. In such a case, the management apparatus 20 should simultaneously send each communication and information processing apparatus 10 a request to measure RTTc's 73 to the plurality of clients 40, instead of individually performing the selecting and assigning a communication and information processing apparatus 10 in Embodiment 1 for the plurality of clients 40.

In this case, each communication and information processing apparatus 10 notifies the management apparatus 20 of measured RTTc's 73 from all the clients 40.

If required is merely to satisfy the required RTTr's of the clients 40, the management apparatus 20 extracts a communication and information processing apparatus 10 satisfying all the required RTTr's of the clients 40 and, if the longest RTTc 73 among all the RTTc's 73 satisfies the required RTTr's, proceeds to YES from Step S413 in FIG. 7A.

Alternatively, if it is important that the communication delays from all the clients 40 are equal, the management apparatus 20 extracts a communication and information processing apparatus 10 satisfying all the required RTTr's of the clients 40 and, if all the RTTc's 73 are evenly the same value, proceeds to YES from Step S413 in FIG. 7A.

### Embodiment 3

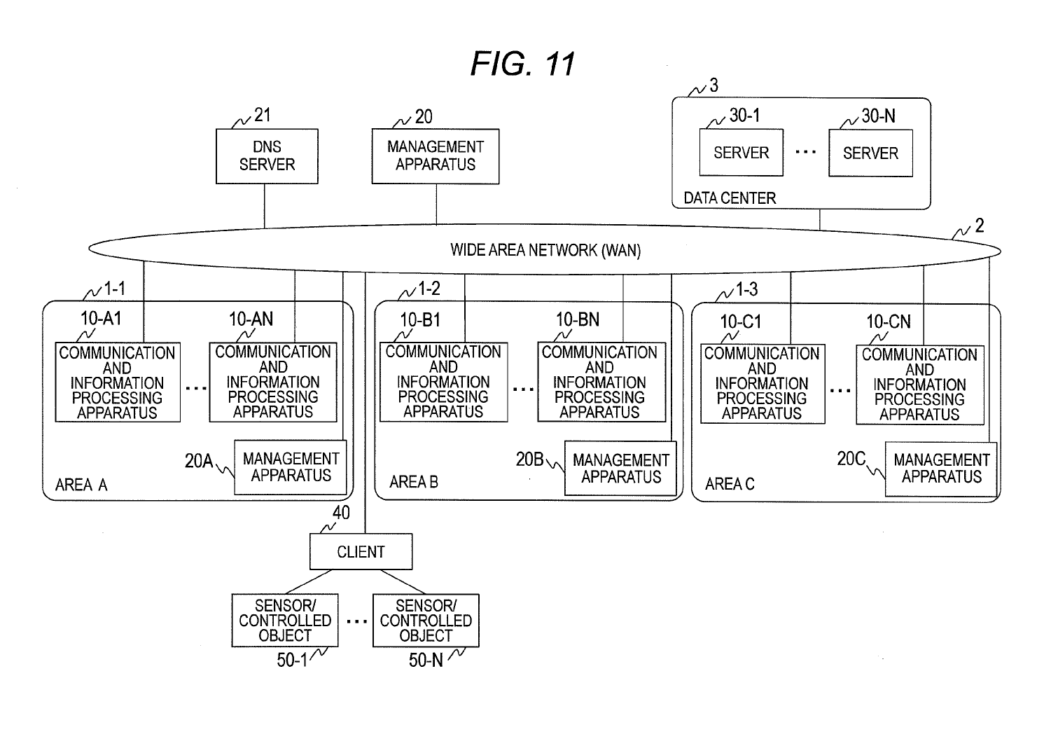

The foregoing Embodiment 1 described an example where the management apparatus 20 is a single apparatus; however, the management apparatus 20 may be organized hierarchically. FIG. 11 illustrates a third embodiment and is a block diagram illustrating an example of distributed processing system.

In FIG. 11, the management apparatus 20 is the highest-order management apparatus and lower-order management apparatuses 20A to 20C are distributed to the areas 1-1 to 1-3. The management apparatus 20A manages the communication and information processing apparatuses 10-A1 to 10-AN in the area 1-1; the management apparatus 20B manages the communication and information processing apparatuses 10-B 1 to 10-BN in the area 1-2; the management apparatus 20C manages the communication and information processing apparatuses 10-C1 to 10-CN in the area 1-3; and the management apparatus 20 hierarchically manages the management apparatuses 20A to 20C in the areas 1-1 to 1-3. Except for these, the configuration is the same as that in the foregoing Embodiment 1.

In this Embodiment 3, the sequence diagram of FIG. 5 additionally includes a step that the highest-order management apparatus 20 notifies the lower-order management apparatus 20A in the area 1-1 of the contents of its own communication and information processing apparatus management table 621.

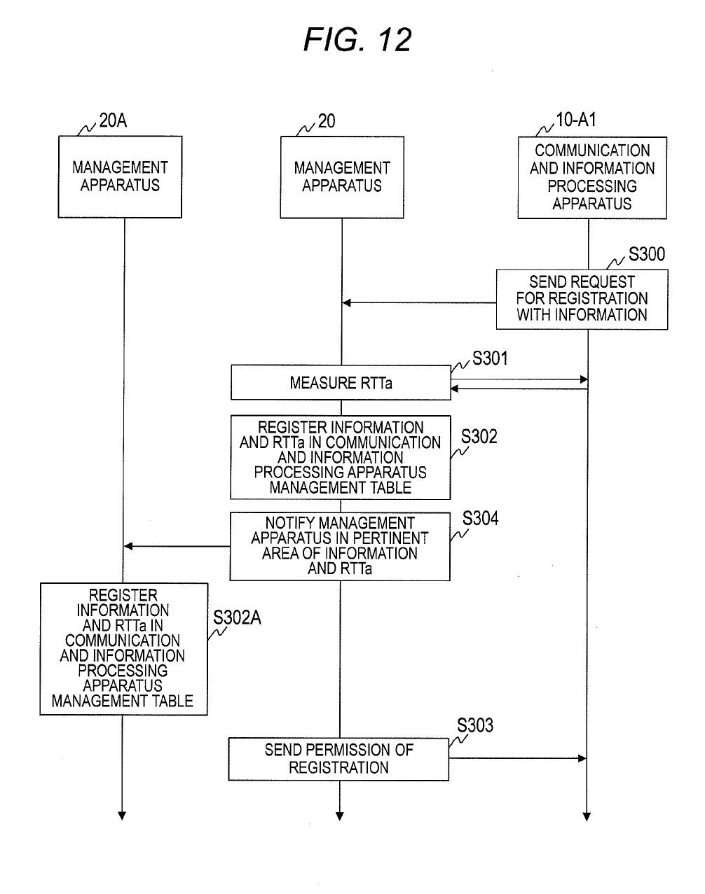

FIG. 12 is a sequence diagram illustrating an example of processing to register a communication and information processing apparatus in the distributed processing system. After Step S302 of the sequence diagram of FIG. 12, the highest-order management apparatus 20 notifies the lower-order management apparatus 20A in the pertinent area of the information on the communication and information processing apparatus 10A-1 (for example, the amount of information processing resources such as the number of CPU cores, the amount of memory, and the size of hard disk held by the apparatus 10A-1, and the type of the OS as necessary) and the RTTa 71 of the RTT to the communication and information processing apparatus 10A-1 measured by the highest-order management apparatus 20 (Step S304).

The lower-order management apparatus 20A registers the foregoing information and the RTTa 71 in its own communication and information processing apparatus management table 621 (Step S302A).

Thereafter, the highest-order management apparatus 20 issues a permission of registration to the communication and information processing apparatus 10A-1 and terminates the registration, like in Embodiment 1.

In this Embodiment 3, the processing from Step S400 until selection of an area at Step S430 in the sequence diagram of FIG. 6 is performed by the highest-order management apparatus 20 and the selecting communication and information processing apparatuses 10 in the selected area at Step S430 and the subsequent processing are performed by the management apparatus 20A, 20B, or 20C in the area 1.

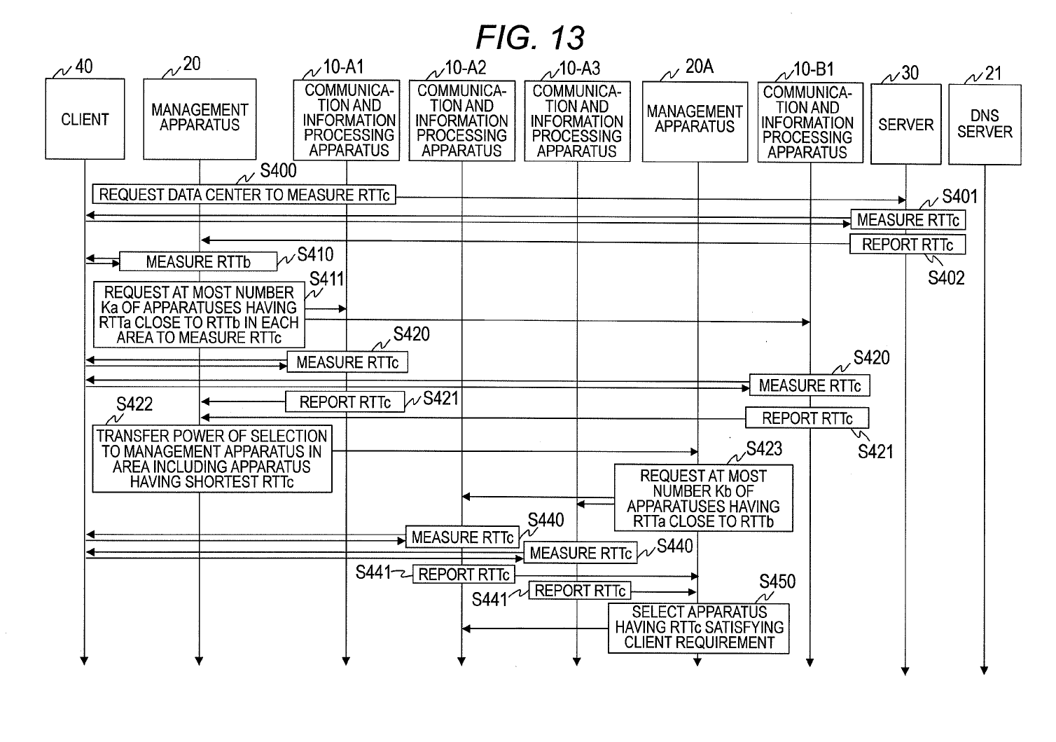

FIG. 13 is a sequence diagram illustrating an example of selecting a communication and information processing apparatus in the distributed processing system. As shown in FIG. 13, the highest-order management apparatus 20 transfers the power of selection to the management apparatus in the area the communication and information processing apparatus 10 having the shortest RTTc 73 belongs to (in this example, the management apparatus 20A in Area A). This corresponds to the processing until selection of an area at Step S430 in the flowchart of FIG. 6.

The lower-order management apparatus 20A that has received the power of selection searches its own communication and information processing apparatus management table 621 and selects at most the operator-specified number (for example, Kb) of communication and information processing apparatuses 10 each having an RTTa close to the RTTb 72 described in Embodiment 1 in the field of RTTa 703 (meaning the absolute value of the difference ΔRTT is the threshold ΔTh or less) and having unused resources in the amount required by the client 40 in the field of amount of unused resources 705. Here, the value for the specified number Kb (second predetermined number) may be determined at, for example, a number less than 10 and usually, about 3. The management apparatus 20A requests each of the selected number Kb of communication and information processing apparatuses 10 to measure the RTTc 73 to the client 40 (Step S423). This corresponds to the transfer of processing of selecting a communication and information processing apparatus 10 in the selected area at Step S430 of the sequence diagram of FIG. 6.

Each of the communication and information processing apparatuses 10 requested to measure the RTTc 73 by the lower-order management apparatus 20A measures the RTTc 73 of the RTT to the designated client 40 (Step S440) and notifies the lower-order management apparatus 20A of the measured RTTc 73 (Step S441).

Upon receipt of RTTc's 73 from all the selected communication and information processing apparatuses 10, the lower-order management apparatus 20A determines whether any RTTc 73 satisfies the required RTTr of the client 40. If one RTTc 73 satisfies the required RTTr, the management apparatus 20A assigns the communication and information processing apparatus 10 to the client 40 (Step S450). If a plurality of RTTc's 73 satisfy the required RTTr, the lower-order management apparatus 20A selects the communication and information processing apparatus 10 having the shortest RTTc 73 and assigns the processing for the client 40 to it (Step S450).

In the third embodiment, the selecting communication and information processing apparatuses 10 in a selected area and the subsequent processing are transferred to be performed by the management apparatus 20A, 20B, or 20C in the area 1; accordingly, the load to the highest-order management apparatus 20 can be reduced.

### Embodiment 4

The foregoing Embodiment 1 described an example where the information processing function unit 200 of a communication and information processing apparatus 10 runs the management program 211, the RTT measurement program 212, and the user program 113 on a physical computer. The fourth embodiment provides an example where this invention has been applied to a virtual machine system.

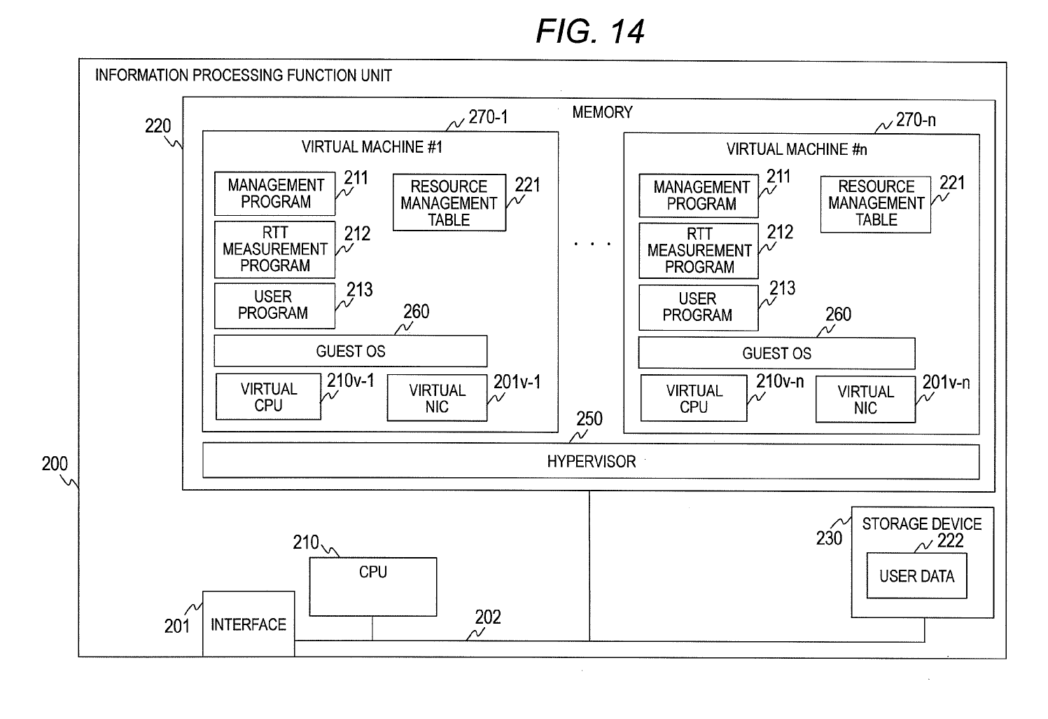

FIG. 14 is a block diagram illustrating an example of the configuration of the information processing function unit 200 of a communication and information processing apparatus 10 in the case where this invention has been applied to a virtual machine system.

The CPU 210 in the information processing function unit 200 executes a hypervisor 250 loaded to the memory 220. The hypervisor 250 allocates virtual machine resources obtained by virtualizing the physical computer resources of the information processing function unit 200 to virtual machines 270-1 to 270-n. The virtual machine resources such as virtual CPUs 210v-1 to 210v-n obtained by virtualizing the CPU 210 and virtual NICs 201v-1 to 201v-n obtained by virtualizing the interface 201 are allocated to the virtual machines 270.

Each virtual machine 270 runs a management program 211, an RTT measurement program 212, and a user program 213 on a guest OS 260. These programs 211 to 213 are the same as those in the first embodiment. The RTT measurement program 212 communicates with the management apparatus 20 and the client 40 from the virtual NIC 201v via the interface 201, the communication function unit 100 shown in FIG. 8, and the WAN 2.

Accordingly, the first round trip time RTTa 71 shown in FIG. 2 to be measured by the management apparatus 20 is defined as the RTT from the interface (communication interface) 201 of the management apparatus 20 to the virtual NIC 201v in the virtual machine 270. In similar, the third round trip time RTTc 73 to be measured by the RTT measurement program 212 on the virtual machine 270 is defined as the RTT from the virtual NIC 201v to the communication interface (not shown) of the client 40. The others are the same as those in the foregoing Embodiment 1; this invention is also applicable to a virtual machine system.

The foregoing embodiments provided examples where a communication and information processing apparatus 10 includes a communication function unit 100 and an information processing function unit 200; however, each area 1 may be configured to include one or more communication apparatuses each including a communication function unit 100 and one or more information processing apparatuses each including an information processing function unit 200.

The computers, processing units, and processing means described related to this invention may be, for a part or all of them, implemented by dedicated hardware.

The foregoing embodiments provided examples where the management apparatus 20 and the areas 1 are coupled via the WAN 2; however, the WAN 2 may be a different kind of network such as the Internet.

The variety of software exemplified in the embodiments can be stored in various media (for example, non-transitory storage media), such as electro-magnetic media, electronic media, and optical media and can be downloaded to a computer through communication network such as the Internet.

This invention is not limited to the foregoing embodiments but includes various modifications. For example, the foregoing embodiments have been provided to explain this invention to be easily understood; they are not limited to the configurations including all the described elements.

What is claimed is:

1. A distributed processing system comprising:
a plurality of information processing apparatuses for performing information processing;
one or more client computers for requesting the information processing; and
a management apparatus for managing the plurality of information processing apparatuses and the one or more client computers,
the plurality of information processing apparatuses, the one or more client computers, and a management apparatuses being coupled via a network,
wherein one of the one or more client computers sends the management apparatus a request for information processing including a required round trip time of a value required for a round trip time,
wherein the management apparatus includes:
a management unit for selecting an information processing apparatus to perform the information processing requested by the client computer from the plurality of information processing apparatuses and assigning the information processing requested by the client computer to the selected information processing apparatus; and
a communication delay measurement unit for measuring round trip times via the network,
wherein the communication delay measurement unit measures first round trip times between the management apparatus and the plurality of information processing apparatuses and a second round trip time between the management apparatus and the client computer and requests information processing apparatuses with which absolute values of differences between the first round trip times and the second round trip time are equal to or less than a predetermined threshold to measure third round trip times between the information processing apparatuses and the client computer,
wherein the information processing apparatuses measure the third round trip times to the client computer and transmit the measured third round trip times to the management apparatus, and
wherein the management unit assigns the information processing requested by the client computer to an information processing apparatus to which the transmitted third round trip time is equal to or shorter than the required round trip time of the client computer.

2. A distributed processing system according to claim 1,
wherein the management unit holds management information for managing computer resources of the plurality of information processing apparatuses;
wherein, in the requesting information processing apparatuses to measure third round trip times between the information processing apparatuses and the client computer, the communication delay measurement unit refers to the management information to request only information processing apparatuses having computer resources available to be used to measure the third round trip times.

3. A distributed processing system according to claim 2,
wherein the management unit manages the plurality of information processing apparatuses by groups corresponding to attributes to which the plurality of information processing apparatuses belong by means of the management information,
wherein, in the requesting information processing apparatuses to measure third round trip times between the information processing apparatuses and the client computer, the communication delay measurement unit selects a first predetermined number or less of information processing apparatuses with which absolute values of differences between the first round trip times and the second round trip time are equal to or less than the predetermined threshold from each group and requests the selected information processing apparatuses to measure the third round trip times, and
wherein the management unit assigns the information processing requested by the client computer to an information processing apparatus to which the transmitted third round trip time is equal to or shorter than the required round trip time of the client computer among the first predetermined number or less of information processing apparatuses selected from each group to measure the third round trip times.

4. A distributed processing system according to claim 3,
wherein, in a case of no information processing apparatus to which the transmitted third round trip time is equal to or shorter than the required round trip time of the client computer among the first predetermined number or less of information processing apparatuses selected from each group, the communication delay measurement unit selects a second predetermined number or less of information processing apparatuses with which absolute values of differences between the first round trip times and the second round trip time are equal to or less than a predetermined threshold from a group including the shortest third round trip time and requests the selected information processing apparatuses to measure third round trip times, and
wherein the management unit assigns the information processing requested by the client computer to an information processing apparatus to which the transmitted third round trip time is equal to or shorter than the required round trip time of the client computer among the third round trip times transmitted from the selected second predetermined number or less of information processing apparatuses.

5. A distributed processing system according to claim 4,
wherein, in the selecting a second predetermined number or less of information processing apparatuses with which absolute values of differences between the first round trip times and the second round trip time are equal to or less than a predetermined threshold from a group including the shortest third round trip time, the communication delay measurement unit refers to the management information to select only information processing apparatuses having remaining computer resources available to be used as information processing apparatuses to measure third round trip times, and repeats comparison of the measured third round trip times with the required round trip time within a predetermined number of times.

6. A distributed processing system according to claim 3,
wherein the attributes for the groups are names of areas where the plurality of information processing apparatuses are distributed, and
wherein the management information holds the names of areas to which the plurality of information processing apparatuses belong, the first round trip times of the plurality of information processing apparatuses measured in advance, and amounts of computer resources available to be used in the plurality of information processing apparatuses.

7. A distributed processing system according to claim 1,
wherein the communication delay measurement unit measures the first round trip time in registration of each of the plurality of information processing apparatuses in the management apparatus, and
wherein the communication delay measurement unit measures the second round trip time in registration of each of the one or more client computers in the management apparatus.

8. A distributed processing system according to claim 1,
wherein the management apparatus actively measures the first round trip times and the second round trip time; and
wherein the plurality of information processing apparatuses actively measure the third round trip times.

9. A distributed processing system according to claim 1,
wherein the plurality of information processing apparatuses actively measure the first round trip times and the client computer actively measures the second round trip time, and
wherein the client computer actively measures the third round trip times.

10. A distributed processing system according to claim 3,
wherein the management apparatus includes:
a first management apparatus for managing the overall distributed processing system; and
a second management apparatus for each of the groups,
wherein the first management apparatus performs the receiving of a request from a client computer and the determination of a group, and
wherein the second management apparatus for the group performs the assignment of the information processing requested by the client computer to the information processing apparatus in the group.

11. A distributed processing system according to claim 1,
wherein, in a case where a user uses a plurality of client computers, the management apparatus selects an information processing apparatus from which third round trip times to the plurality of client computers are equal to or shorter than required round trip times of the plurality of client computers and the third round trip times are almost equal.

12. A method of managing a distributed processing system in which a plurality of information processing apparatuses for performing information processing, one or more client computers for requesting the information processing, and a management apparatus for managing the plurality of information processing apparatuses and the one or more client computers are coupled via a network and the management apparatus assigns the information processing requested by one of the one or more client computers to one of the plurality of information processing apparatus, the method comprising the steps of:
a first step of sending, by one of the one or more client computers, the management apparatus a request for information processing including a required round trip time of a value required for a round trip time;
a second step of measuring, by the management apparatus, first round trip times between the management apparatus and the plurality of information processing apparatuses and a second round trip time between the management apparatus and the client computer;
a third step of requesting, by the management apparatus, information processing apparatuses with which absolute values of differences between the first round trip times and the second round trip time are equal to or less than a predetermined threshold to measure third round trip times between the information processing apparatuses and the client computer;
a fourth step of measuring, by the information processing apparatuses, the third round trip times to the client computer and transmitting the measured third round trip times to the management apparatus; and
a fifth step of assigning, by the management apparatus, the information processing requested by the client computer to an information processing apparatus to which the transmitted third round trip time is equal to or shorter than the required round trip time of the client computer.

13. A method of managing the distributed processing system according to claim 12,
wherein the management apparatus holds management information for managing computer resources of the plurality of information processing apparatuses,
wherein the third step includes referring to, by the management apparatus, the management information to request only information processing apparatuses having computer resources available to be used to measure the third round trip times in the requesting information processing apparatuses to measure the third round trip times between the information processing apparatuses and the client computer.

14. A method of managing the distributed processing system according to claim 13,
wherein the management apparatus manages the plurality of information processing apparatuses by groups corresponding to attributes to which the information processing apparatuses belong by means of the management information,
wherein the third step includes selecting, by the management apparatus, a first predetermined number or less of information processing apparatuses with which absolute values of differences between the first round trip times and the second round trip time are equal to or less than the predetermined threshold from each group and requesting the selected information processing apparatuses to measure third round trip times in the requesting information processing apparatuses to measure the third round trip times between the information processing apparatuses and the client computer, and
wherein the fifth step includes assigning, by the management apparatus, the information processing requested by the client computer to an information processing apparatus to which the transmitted third round trip time is equal to or shorter than the required round trip time of the client computer among the first predetermined number or less of information processing apparatuses selected from each group to measure the third round trip times.

15. A method of managing the distributed processing system according to claim 14,
wherein the third step includes selecting, by the management apparatus, a second predetermined number or less of information processing apparatuses with which absolute values of differences between the first round trip times and the second round trip time are equal to or less than a predetermined threshold from a group including the shortest third round trip time and requesting the selected information processing apparatuses to measure third round trip times in a case of no information processing apparatus to which the transmitted third round trip time is equal to or shorter than the required round trip time of the client computer among the first predetermined number or less of information processing apparatuses selected from each group, and
wherein the fifth step includes assigning, by the management apparatus, the information processing requested by the client computer to an information processing apparatus to which the transmitted third round trip time is equal to or shorter than the required round trip time of the client computer among the third round trip times transmitted from the selected second predetermined number of information processing apparatuses.
